(19) United States
(12) Patent Application Publication
(10) Pub. No.: US 2012/0157567 A1
(43) Pub. Date: Jun. 21, 2012

(54) SILICONE COMPOSITION, AN ARTICLE AND METHOD OF MAKING AN ARTICLE

(75) Inventors: Duan Li Ou, Watchung, NJ (US); Heidi Sardinha, Shrewsbury, MA (US); Mark W. Simon, Pascoag, RI (US)

(73) Assignee: SAINT-GOBAIN PERFORMANCE PLASTICS CORPORATION, Aurora, OH (US)

(21) Appl. No.: 13/328,946

(22) Filed: Dec. 16, 2011

Related U.S. Application Data
(60) Provisional application No. 61/423,850, filed on Dec. 16, 2010.

(51) Int. Cl. C08L 83/04; C08L 83/08; C08L 83/16

(52) U.S. Cl. 523/122; 525/474; 525/477; 525/479

(57) ABSTRACT

The disclosure is directed to a silicone composition. The silicone composition includes a silicone matrix component, an adhesion promoter, and a quaternary ammonium salt containing polymer, wherein the quaternary ammonium salt containing polymer is in an amount to provide a bactericidal effect to the silicone composition. The disclosure is further directed to an article made thereof and to methods for making the article.

### CROSS-REFERENCE TO RELATED APPLICATION(S)

The present application claims priority from U.S. Provisional Patent Application No. 61/423,850, filed Dec. 16, 2010, entitled “A SILICONE COMPOSITION, AN ARTICLE AND METHOD OF MAKING AN ARTICLE,” naming inventors Duan Li Ou, Heidi Sardinha and Mark W. Simon, which application is incorporated by reference herein in its entirety.

### FIELD OF THE DISCLOSURE

This disclosure, in general, relates to a silicone composition, an article, and a method of forming an article.

### BACKGROUND

Antimicrobials are essential for material applications to prevent microorganism contamination. Various metal additives such as silver, copper, and zinc are known to introduce antimicrobial characteristics in polymers. These approaches rely on ion-release mechanism for antimicrobial performance which causes their efficacy to decrease with time. Furthermore, there is increasibly regulatory pressure against heavy metals such as silver which is a common antimicrobial additive. Accordingly, the use of quaternary ammonium materials has been adopted to introduce antimicrobial properties.

In many cases, the polymers having antimicrobial characteristics may be incorporated into a resin to impart antimicrobial properties to the resin. In particular, there is a need to provide long-lasting antimicrobial properties throughout a substrate. Furthermore, there is a need to provide antimicrobial properties to a substrate that may be useful as a coating or a laminate over a variety of polymer or metal substrates. However, manufacturers of products are limited in their ability to customize formulations to suit a particular product or process.

As such, improved antimicrobial compositions and methods of making the compositions would be desirable.

### SUMMARY

In a particular embodiment, a silicone composition includes a silicone matrix component, an adhesion promoter, and a quaternary ammonium salt containing polymer, wherein the quaternary ammonium salt containing polymer is in an amount to provide a bactericidal effect to the silicone composition.

In another embodiment, a method of making an article includes mixing a silicone matrix component, an adhesion promoter, and a quaternary ammonium salt containing polymer in a mixing device to form a silicone composition, wherein the quaternary ammonium salt containing polymer is added in an amount to provide a bactericidal effect to the silicone composition, and forming the silicone composition into an article.

In another exemplary embodiment, an article includes at least one layer of a silicone composition including a silicone matrix component, an adhesion promoter, and a quaternary ammonium salt containing polymer, wherein the quaternary ammonium salt containing polymer is provided in an amount to provide a bactericidal effect to the silicone composition.

### DETAILED DESCRIPTION

In an embodiment, a silicone composition includes a silicone matrix component, an adhesion promoter; and a quaternary ammonium salt containing polymer. The quaternary ammonium salt containing polymer is provided in an amount to provide a bactericidal effect to the silicone composition. In a particular embodiment, the bactericidal effect is for a sustained period of time without leaching of the quaternary ammonium salt containing polymer into its surrounding environment.

The silicone composition contains a quaternary ammonium salt containing polymer to provide a bactericidal effect to the silicone composition. The quaternary ammonium salt containing polymer is a polymer having a Formula I:

R₃N⁺R⁰ₙSiY⁻ (I)

wherein each R and each R⁰ is independently, a non-hydrolysable organic group; n is an integer of 0 to 3; and Y is a suitable anionic moiety to form the salt of the compound of Formula I.

In an embodiment, each R and each R⁰ is independently a non-hydrolysable organic group, such as, without limitation, an alkyl group of 1 to about 22 carbon atoms or an aryl group, for example, phenyl; n is an integer of 0 to 3. For instance, each of the R groups is independently methyl, ethyl, propyl, butyl, octyl, dodecyl, tetradecyl or octadecyl and each of the R⁰ groups is independently methylenyl, ethylenyl, propylenyl, butylenyl, octylenyl, dodecylenyl, tetradecylenyl or octadecylenyl. Typically, Y is a suitable anionic moiety to form the salt of the polymer of Formula I, such as halide, hydroxyl, acetate, SO4⁻², CO₃⁻² and a PO₄⁻² counter ion. In an embodiment, Y is a halide. In an exemplary embodiment, the silicon-containing quaternary ammonium salt has repeating units wherein two of the Rs are methyl and one R is octadecyl, R⁰ is propylenyl, n is 1 and Y is chloride, such that the polymer is polymeric 3-(trimethoxysilyl)propyldimethyloctadecyl ammonium chloride.

In a particular embodiment, the quaternary ammonium salt monomer used to make the polymer of Formula I has a Formula II:

R₃N⁺R⁰ₙSiX₄₋ₙY⁻ (II)

wherein each R and each R⁰ is, independently, a non-hydrolysable organic group as described above; each X is, independently, a hydrolysable group; n is an integer of 0 to 3; and Y is a suitable anionic moiety to form the salt of the compound Formula II. In an embodiment, Y is a halide. In a particular embodiment, the silicon-containing quaternary ammonium salt is where two of the Rs are methyl and one R is octadecyl, R⁰ is propylenyl, each X is a methoxy, n is 1 and Y is chloride, such that the monomeric quaternary ammonium salt is 3-(trimethoxysilyl) propyldimethyloctadecyl ammonium chloride.

In an embodiment, the quaternary ammonium salt monomer is selected from the group of one of Formula III or IV:

(R¹)₃SiR²N⁺(R³)(R⁴)(R⁵)Y⁻ (III);

(R¹)₃SiR²N(R³)(R⁴) (IV);

wherein each R¹ is, independently, halogen or R⁶O, where R⁶ is H, alkyl of 1 to about 22 carbon atoms, acetyl, acetoxy, acyl, propylene glycol, ethylene glycol, polyethylene glycol, polypropylene glycol; a block polymer or copolymer of ethylene and propylene glycol, an alkyl monoether of 1 to about 22 carbon atoms of propylene glycol, ethylene glycol, polyethylene glycol, polypropylene glycol; a block polymer or copolymer of ethylene and propylene glycol or the monoester of a carbonic acid of 1 to about 22 carbon atoms and propylene glycol, ethylene glycol, polyethylene glycol, polypropylene glycol; a block polymer or copolymer of ethylene and propylene glycol; octyphenol; nonylphenol; or sorbitan ether;

R² is benzyl, vinyl or alkyl of 1 to about 22 carbon atoms;

R³ and R⁴ are, independently, lower alkyl alcohol of 1 to about 6 carbon atoms, lower alkoxy of 1 to about 6 carbon atoms, alkyl of 1 to about 22 carbon atoms; or R³ and R⁴ can, together, form a morpholine or cyclic or heterocyclic, unsaturated or saturated, five to seven-member ring of the Formula V: —R³—(R⁷)ₖ—R⁴— (V) wherein k is an integer from 0 to 2,

wherein R⁷, where the ring is saturated, is CH₂, O, S, NH, NH₂⁺, NCH₂CH₂NH₂, NCH₂CH₂NH₃⁺, NCH₂CH₂N(R⁸)(R⁹), NCH₂CH₂N⁺(R⁸)(R⁹)(R¹⁰), N(alkyl), N(aryl), N(benzyl), wherein each R⁸, R⁹, and R¹⁰ is, independently, benzyl, polyether, lower alkyl alcohol of 1 to 4 carbon atoms, lower alkoxy of 1 to 4 carbon atoms, or alkyl of 1 to about 22 carbon atoms, and wherein R⁷, where the ring is unsaturated, is CH, N, N⁺H, N⁺(alkyl), N⁺(aryl), N⁺(benzyl), NCH₂N, N⁺HCH₂N, N⁺(alkyl)CH₂N, N⁺(aryl)CH₂N, or N⁺(benzyl)CH₂N; wherein the ring is unsubstituted or substituted with alkyl of 1 to 22 carbon atoms, ester, aldehyde, carboxylate, amide, thionamide, nitro, amine, or halide;

R⁵ is lower alkyl alcohol of 1 to 6 carbon atoms, CH₂C₆H₅, polyether, alkyl, alkoxy, perfluoroalkyl, pefluoroalkylsulfonate or perfluoroalkylcarboxylate, wherein the alkyl, alkoxy, perfluoroalkyl, perfluoroalkylsulfonate or perfluoroalkylcarboxylate is of 1 to about 22 carbon atoms, or is a five to seven-member ring of Formula V as described above; and

Y⁻ is a suitable anionic moiety to form the salt of the compound of Formula III or IV, and in an embodiment, chloride, bromide or iodide.

One method of preparing an exemplary quaternary ammonium salt containing polymer includes adding with agitation the silicon-containing quaternary ammonium salt monomer to an excess of solvent, such as water, along with heat and/or a catalyst such as a mineral or organic acid or base, which initiates the polymerization process. The polymer is recovered from resulting precipitation or solvent removal.

For instance, one embodiment of the method of making the polymer of Formula I includes (a) providing a monomeric silicon-containing quaternary ammonium salt of Formula II that is capable of forming the polymer having the repeating units of Formula I; (b) hydrolysing the monomer of Formula II with water to form Si(OH) groups; and (c) condensing the Si(OH) groups to form the polymer of Formula I.

In a specific embodiment, the method may further include a preliminary step before step (a) that includes dissolving the monomeric silicon-containing quaternary ammonium salt in a solvent to form a solution; the hydrolysis step (b) may further include mixing the solution and water in the presence of heat and/or a catalyst; the condensation step (c) typically further includes subjecting the solution undergoing hydrolysis to heat and/or removal of water or the other solvent to drive the reaction further to completion to form the polymer; and the method may further include a step (d) of recovering the polymer by precipitation and solvent removal. A typical further step of the method includes step (e) of drying the recovered polymer, such as by heating to evaporate the solvent, resulting in the polymer being solvent-free. “Solvent-free” as used herein means that the polymer may contain residual solvent up to about 10 weight percent of the polymer.

The solvent may be any suitable solvent, such as, without limitation, water; an alcohol, such as ethanol, propanol, isopropanol or butanol; a ketone, such as methyl ethyl ketone; an aldehyde, such as butyl aldehyde; an aliphatic hydrocarbon, such as pentane or hexane; an aromatic hydrocarbon, such as toluene or xylene; a glycol ether, such as diethylene glycol monomethyl ether or ethylene glycol dibutyl ether; a halogenated hydrocarbon, such as 1,1,1-trichloroethane or tetrachloroethane, and mixtures thereof. In an exemplary embodiment, the solvent includes, without limitation, water, alcohols such as isopropyl alcohol and t-butyl alcohol, tetrahydrofuran, chloroform, carbon tetrachloride, ethylene glycol, propylene glycol, ethyl acetate, and mixtures thereof. If water is the only solvent, there is typically a molar excess to hydrolyse the Si—OR groups to Si—OH. If the reaction is conducted in another solvent, a stoichiometric amount of water is added to hydrolyse the Si—OR groups.

In an embodiment, a catalyst may be used to produce the quaternary ammonium salt containing polymer. Exemplary catalysts include a mineral acid, an organic acid or a base. In a particular embodiment, the acid is hydrochloric acid, sulfuric acid or acetic acid. In a particular embodiment, the base is sodium hydroxide, potassium hydroxide, ammonium hydroxide, an aliphatic amine, such as dimethylamine, tetramethylenediamine or hexamethylenediamine, a cycloaliphatic amine such as morpholine or cyclohexylamine, or an aryl amine such as aniline or diphenylamine.

The antimicrobial silicon-containing quaternary ammonium salt solution includes as a solvent for the antimicrobial agent any solvent that may effectuate the conversion of the hydrolysable groups, such as the methoxy groups, on the silicon-containing quaternary ammonium salt to OH groups. In an embodiment, for the antimicrobial silicon-containing quaternary ammonium salt solution, the solvent is selected based on its ability to dissolve the antimicrobial silicon-containing quaternary ammonium salt. The concentration of the solution may be about 1% to about 99% by weight of the antimicrobial silicon-containing quaternary ammonium salt. In a particular embodiment, about 1% to about 75% by weight of the antimicrobial silicon-containing quaternary ammonium salt is used, and in an embodiment, about 1% to about 50% by weight is used.

After the silicon-containing quaternary ammonium salt monomer has been combined with the solvent, the silicon-containing quaternary ammonium salt is polymerized to form the antimicrobial homopolymer. Such polymerization is typically achieved by mixing the solution of the silicon-containing quaternary ammonium salt monomer used to form the polymeric antimicrobial agent with a catalyst, which may be a base, such as those mentioned above, an acid, such as those mentioned above, or heat, or a combination of a base or acid and heat. The base and acid may have concentrations of about 0.0N to about 1N. An effective temperature for polymerization is about 10° C. to about 300° C., such as about 30° C. to about 100° C., or even about 20° C. to about 50° C. In general, the greater the temperature, the less time it takes for the antimicrobial polymer to form.

The method of making the antimicrobial polymer described above creates an antimicrobial quaternary ammonium salt containing polymer, which can be incorporated into resins and materials to create substrates with sustained antimicrobial properties. The solid antimicrobial polymer can be used to treat materials by different methods of incorporating the antimicrobial polymer into the materials. In a particular embodiment, the quaternary ammonium salt containing polymer is incorporated by any reasonable means. For instance, the quaternary ammonium salt containing polymer may be dry blended with a bulk resin (such as in powder, flake, pellets, bead form) prior to forming the article. In an embodiment, the quaternary ammonium salt containing polymer is added to the resin or material in a masterbatch. For instance, the masterbatch is made by compounding the quaternary ammonium salt in to a vinyl endblocked dimethyl polymer in a Ross mixer for a time of about one hour with a weight percent of about 40 weight % to about 60 weight % quaternary ammonium salt and about 60 weight % to about 40 weight % vinyl endblocked dimethyl polymer.

A typical silicone composition that may include the antimicrobial polymer is a silicone matrix component. In an exemplary embodiment, the silicone matrix component is a self-bonding silicone matrix component. In an embodiment, the quaternary ammonium salt containing polymer is blended with the self-bonding silicone matrix component. Self-bonding silicone matrix components are typically silicone matrix components that adhere to other surfaces without the need for a primer between the self-bonding silicone matrix component and the surface to which it adheres. An exemplary silicone matrix component includes a polyalkylsiloxane, a fluorosilicone, or combination thereof. Any reasonable polyalkylsiloxane is envisioned. Polyalkylsiloxanes include, for example, silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In a particular embodiment, the polyalkylsiloxane is a silicone hydride-containing polydimethylsiloxane. In a further embodiment, the polyalkylsiloxane is a vinyl-containing polydimethylsiloxane. In yet another embodiment, the silicone matrix component is a combination of a hydride-containing polydimethylsiloxane and a vinyl-containing polydimethylsiloxane. In an example, the polyalkylsiloxane is non-polar and is free of halide functional groups, such as chlorine and fluorine, and of phenyl functional groups. Alternatively, the polyalkylsiloxane may include halide functional groups or phenyl functional groups.

Typically, the silicone matrix component is elastomeric. For example, the durometer (Shore A) of the silicone matrix component may be less than about 75, such as about 1 to 70, about 20 to about 50, about 30 to about 50, about 40 to about 50, or about 1 to about 5.

The self-bonding silicone matrix component may further include a catalyst and other optional additives. Exemplary additives may include, individually or in combination, fillers, inhibitors, colorants, and pigments. In an embodiment, the self-bonding silicone matrix component is a platinum catalyzed polyalkylsiloxane. Alternatively, the self-bonding matrix component may be a peroxide catalyzed polyalkylsiloxane. In another example, the self-bonding silicone matrix component may be a combination of a platinum catalyzed and peroxide catalyzed polyalkylsiloxane. The polyalkylsiloxane may be a room temperature vulcanizable (RTV) formulation, a gel, or a foam. In an example, the polyalkylsiloxane may be a liquid silicone rubber (LSR) or a high consistency gum rubber (HCR).

Another exemplary silicone matrix component is a fluorosilicone. Any reasonable fluorosilicone is envisioned. Fluorosilicone is the common name for fluorovinylmethyl silicone rubber. Fluorosilicones combine the advantageous properties of fluorocarbons and silicones. For instance, fluorosilicones resist solvents, fuel, and oil (similar to fluorocarbons). They also have high and low temperature stability (as with silicones). The typical temperature range for fluorosilicone is about −70° C. to about 177° C. Some examples of commercially available fluorosilicone includes FE® (Shin-Etsu), FSE® (Momentive) and Silastic LS® (Dow Corning Corp.).

The silicone matrix component is self-bonding through the addition of an adhesion promoter. In an embodiment, the adhesion promoter may include vinyl siloxane or silsesquioxane. In an example, the silsesquioxane includes an organosilsesquioxane or a vinyl-containing silsesquioxane. For example, the vinyl-containing silsesquioxane may include R¹²SiO3_{/2} units, wherein R¹² is a vinyl group, an alkyl group, an alkoxy group, a phenyl group, or any combination thereof. Typically, the silsesquioxane has a vinyl content of at least about 30.0% by weight. In an embodiment, the alkyl or alkoxy group includes a C₁₋₆ hydrocarbon group, such as a methyl, ethyl, or propyl group. The adhesion promoter may include R₂¹³SiO_{2/2} units, R₃¹³SiO_{1/2} units and SiO_{4/2}units, wherein R¹³ is an alkyl radical, alkoxy radical, phenyl radical, or any combination thereof. In an embodiment, the vinyl-containing silsesquioxane may include pre-hydrolyzed silsesquioxane prepolymers, monomers, or oligomers.

In addition, the silsesquioxane may have desirable processing properties, such as viscosity. In particular, the viscosity may provide for improved processing in situ, such as during silicone formulation mixing or extrusion. For example, the viscosity of the silsesquioxane may be about 1.0 centistokes (cSt) to about 8.0 cSt, such as about 2.0 cSt to about 4.0 cSt, or about 3.0 cSt to about 7.0 cSt. In an example, the viscosity of the silsesquioxane may be up to about 100.0 cSt, or even greater than about 100.0 cSt.

In an embodiment, the adhesion promoter may include an ester of unsaturated aliphatic carboxylic acids. Exemplary esters of unsaturated aliphatic carboxylic acids include C₁₋₈ alkyl esters of maleic acid and C₁₋₈ alkyl esters of fumaric acid. In an embodiment, the alkyl group is methyl or ethyl. In a particular embodiment, the adhesion promoter is dimethyl maleate, diethyl maleate, or any combination thereof.

In an embodiment, one or more of the above-mentioned adhesion promoters may be added to the silicone matrix component. For instance, the adhesion promoter may include a mixture of the silsesquioxane and the ester of unsaturated aliphatic carboxylic acid. In an embodiment, the silsesquioxane is an organosilsesquioxane wherein the organo group is a C₁₋₁₈ alkyl. In an embodiment, the adhesion promoter is a mixture of the organosilsesquioxane and diethyl maleate. In another embodiment, the adhesion promoter is a mixture of the organosilsesquioxane and dimethyl maleate. In a particular embodiment, the mixture of the organosilsesquioxane and the ester of unsaturated aliphatic carboxylic acids has a weight ratio of about 1.5:1.0 to about 1.0:1.0. In general, the adhesion promoter is not substantially polymerized with the silicone matrix component.

Generally, the adhesion promoter is present in an effective amount to provide a self-bonding silicone composition which covalently bonds to a substrate. In an embodiment, an “effective amount” is about 0.1 weight % to about 5.0 weight %, such as about 0.1 wt % to about 3.0 wt %, such as about 1.0 wt % to about 3.0 wt %, or about 0.2 wt % to about 1.0 wt % of the total weight of the silicone composition. A typical substrate includes, for instance, a polymer, a metal, or combination thereof. In an embodiment, the polymer includes a polycarbonate, a polyetheretherketone, a fluoropolymer, a polyester, a polyetherimide, a polyphenylsulfone, or any combination thereof. In an embodiment, the metal includes a steel, a stainless steel, an aluminum, a copper, a titanium, or any combination thereof.

Commercially available self-bonding silicone compositions are available from Wacker Silicones of Adrian, Mich., Product Serial Nos. LR 3070, LR 3071, LR 3072, LR3074 and LR 3077. Self-bonding silicone compositions are also available from ShinEtsu of Tokyo, Japan, Product Serial Nos KE2090 and KE2095 and Momentive Company, product No. LIM8040.

A further additive in the silicone matrix component includes a radiation resistant component such as a polar component. An embodiment of the radiation resistant component includes polar silicone oils, such as silicone oils including halide functional groups, such as chlorine and fluorine, and silicone oils including phenyls functional groups. In a particular embodiment, the radiation resistant additive is a fluorosilicone, a phenyl silicone, or combinations thereof. Generally, the radiation resistant component is not terminated with reactive functional groups, such as vinyl and methoxy terminating functional groups. For example, the radiation resistant component may include low molecular weight trifluoropropylmethylsiloxane polymers. In another exemplary embodiment, the radiation resistant component includes low molecular weight polyphenyl methyl siloxane. In a further exemplary embodiment, the radiation resistant component includes a hydrocarbon component. For example, the radiation resistant component may be a hydrocarbon-based additive, such as a petroletum, a paraffin-based wax, a hydrocarbon-based gel, a hydrocarbon-based oil, Vaseline®, and Amogell (available from Aldrich Chemical).

In general, the radiation resistant component is not substantially polymerized with the silicone matrix component. In one particular embodiment, the silicone matrix component is loaded with radiation resistant component in amounts of about 0.1 wt % to about 20 wt %, based on the total weight of the silicone composition. Loading implies that the weight percent of radiation resistant component is based on a weight of the silicone composition. For example, the polymer matrix may be loaded with radiation resistant component in amounts of about 0.5 wt % to about 10 wt %, such as about 0.5 wt % to about 5 wt %, or about 0.5 wt % to about 2 wt %, based on the total weight of the silicone composition.

A further additive to the silicone matrix component may include a synergistic combination of antimicrobial agents including more than one quaternary ammonium salt containing polymer with at least one other antimicrobial agent. Other antimicrobial agents may include, by way of example and not limitation, boric acid, polyhexamethylenebiguanide, hydantoin, a silver salt and a combination thereof.

In the embodiment, a method of making an article is included. The method includes mixing the silicone matrix component, the adhesion promoter, and the quaternary ammonium salt containing polymer in a mixing device to form the silicone composition, wherein the quaternary ammonium salt containing polymer is added in an amount to provide a bactericidal effect to the silicone composition. In a particular embodiment, the quaternary ammonium salt containing polymer is present at about 0.25% to about 5.0% of the total weight of the silicone composition, such as about 0.5% to about 2.0% of the total weight of the silicone composition.

In an embodiment, the solid form of the antimicrobial quaternary ammonium salt containing polymer is used as discrete solid particles of the quaternary ammonium salt containing polymer, the solid form of the antimicrobial agent may be melt blended or the like with the polyalkysiloxane and adhesion promoter, to form the desired antimicrobial bulk polymeric material. Such blending, which may be mixing, extrusion, pultrusion or the like, involves the use of any reasonable mixer or extruder. For instance, the solid antimicrobial agent, the silicone composition resin, and the adhesion promoter, are added to the mixer in the desired proportions and mixed at an elevated temperature where the components melt but do not degrade. The temperature should be sufficient to allow the formerly solid components to flow and uniformly blend with each other. The time to accomplish uniform blending such that a uniform mixture results varies based on the temperature and equipment used, but in general, should be sufficient to provide a uniform blend of the polymeric antimicrobial agent and the polymeric resin, whereby the resulting product will have sustained antimicrobial properties. A suitable temperature is typically about 60° C. to about 350° C., such as about 100° C. to about 325° C., and even about 150° C. to about 300° C. The mixing process results in the polymeric antimicrobial agent being homogenously distributed and blended with the silicone matrix component to form the antimicrobial, self-bonding silicone composition. Subsequently, the silicone composition may be formed into any reasonable article by any reasonable method envisioned. For example, processing of the silicone composition to form the article may include any suitable method such as extrusion, jacketing, braiding, processing as a film, molding, compression molding, overmolding, laminating, coating, and the like.

In an embodiment, the silicone composition may be placed on a substrate such as the polymeric substrate or the metal substrate. In an embodiment, the silicone composition may overlie a substrate. In an example, the silicone composition may be disposed directly on a substrate. In an embodiment, the polymeric substrate may be processed. Processing of the polymeric substrate, particularly the thermoplastic substrates, may include casting, extruding or skiving. In general, the silicone composition including the in situ adhesion promoter exhibits desirable adhesion to a substrate without further treatment of the substrate surface. Alternatively, the substrate may be treated to further enhance adhesion. In an embodiment, the adhesion between the substrate and the silicone composition may be improved through the use of a variety of commercially available surface treatment of the substrate. An exemplary surface treatment may include chemical etch, physical-mechanical etch, plasma etch, corona treatment, chemical vapor deposition, or any combination thereof. In an embodiment, the chemical etch includes sodium ammonia and sodium naphthalene. An exemplary physical-mechanical etch may include sandblasting and air abrasion. In another embodiment, plasma etching includes reactive plasmas such as hydrogen, oxygen, acetylene, methane, and mixtures thereof with nitrogen, argon, and helium. Corona treatment may include the reactive hydrocarbon vapors such as acetone. In an embodiment, the chemical vapor deposition includes the use of acrylates, vinylidene chloride, and acetone.

In an embodiment, radiation crosslinking or radiative curing may be performed on the silicone composition once the article is formed. The radiation may be effective to crosslink the silicone composition. The intralayer crosslinking of polymer molecules within the silicone composition provides a cured material and imparts structural strength to the silicone composition of the article. In addition, radiation may effect a bond between the silicone composition and the substrate, such as through interlayer crosslinking. In a particular embodiment, the combination of interlayer crosslinking bonds between the substrate and the silicone composition present an integrated composite that is highly resistant to delamination, has a high quality of adhesion resistant and protective surface, incorporates a minimum amount of adhesion resistant material, and yet, is physically substantial for convenient handling and deployment of the article. In a particular embodiment, the radiation may be ultraviolet electromagnetic radiation having a wavelength between 170 nm and 400 nm, such as about 170 nm to about 220 nm. In an example, crosslinking may be affected using at least about 120 J/cm² radiation.

Once the article is formed, the article is subjected to thermal treatment for vulcanization. Thermal treatment typically occurs at a temperature of about 125° C. to about 200° C. In an embodiment, the thermal treatment is at a temperature of about 150° C. to about 200° C. Typically, the thermal treatment occurs for a time period of about 10 seconds to about 15 minutes, such as about 10 seconds to about 10 minutes, or even about 10 seconds to about 5 minutes.

In an embodiment, the article may be subjected to a post cure. For instance, the conditions for the post bake aids in the removal of any residual VOCs contained within the article. In an embodiment, post cure may be at a temperature of about 60° C. to about 120° C. Typically, the post cure occurs for a time period of up to about 10 hours. In an embodiment, the post bake is at a temperature of about 60° C. to about 120° C. for a period of about 1 hour to about 10 hours.

In an embodiment, the resulting article may be sterilized by any method envisioned. Exemplary sterilization methods include steam, gamma, ethylene oxide, E-beam techniques, combinations thereof, and the like. In a particular embodiment, the article is sterilized by gamma radiation.

The article can be formed into any desired shape or size using any reasonable techniques. The silicone composition can be used to form articles such as monolayer articles, multilayer articles, or can be laminated, coated, or formed on a substrate. In an example, the silicone composition may be used to form a multilayer film or tape. Multiple layers of the same material or different material can be formed into a laminate. Alternatively, the silicone composition may be used to form an irregularly shaped article. Further, the silicone composition may be used to form fabrics, reinforcements, or foams. Fabrics and reinforcement articles may include glass mats, fiberglass, and polymeric braids such as polyamide or polyester braids.

The resulting silicone composition has sustained antimicrobial properties that will continue to be sustained when the silicone composition is formed into an article of any desired configuration or any formed article made from the silicone composition placed on a substrate. The polymerized silicon-containing quaternary ammonium salt is “anchored” and homogenously dispersed within the silicone composition through physical blending and chemical covalent bonding. In particular, the article has a bactericidal effect of at least about 2.2 log reduction to Escherichia coli, such as least about 3.0 log reduction to Escherichia coli. In a particular embodiment, the bactericidal effect is provided for a time of at least about 6 months, such as up to about one year, or even greater than a year. Furthermore, the quaternary ammonium salt containing polymer does not leach out of the final silicone composition. For instance, after one year, the quaternary ammonium salt containing polymer is undetectable by gas chromatography-mass spectrometry (GC MS).

Further, the silicone composition advantageously exhibits desirable peel strength when applied to a substrate. In particular, the peel strength may be significantly high or the layered structure may exhibit cohesive failure during testing. “Cohesive failure” as used herein indicates that the silicone composition or the substrate ruptures before the bond between the silicone composition and the substrate fails. In an embodiment, the article has a peel strength of at least about 10.0 pounds per inch (ppi), or even enough to lead to cohesive failure, when tested in standard “180°“-Peel configuration at room temperature as molded, or may have a peel strength of at least about 50.0 ppi when adhered to a polymeric substrate, metal substrate, or combinations thereof.

Types of applications for the antimicrobial polymer include as examples, but not limited to, any application where antimicrobial properties and self-bonding properties for a silicone composition are desired. For instance, applications may be for the medical industry, pharma industry, biopharma industry, food and beverage industry, electronic industry, and the like. For instance, applications include a medical device, a surgical tool, a cookware, or an electronic device. Exemplary articles include molded devices, surgical drains, piston valves, intravenous applications, catheters, flexible tubing, silicone handles for cookware, sealants, articles for aircraft, and the like.

### EXAMPLE 1

This example illustrates the process to prepare a self-bonding, antimicrobial silicone. Two formulations are prepared for a performance study in Table 1. Specifically, LSR and HCR silicone formulations are prepared. The former is a Wacker LR3003/50 with about 1.0 wt % of Biosafe's HM4100. The latter is a Wacker 401/40 with about 1.0 wt % of Biosafe. The Biosafe is first dispersed in a vinyl masterbatch in a Ross mixer for about 1 hour at a loading of about 60% called AMB-5. The masterbatch (AMB-5) is made by compounding the quaternary ammonium salt in to a vinyl endblocked dimethyl polymer in a Ross mixer for a time of about one hour with a weight percent of about 40 weight % to about 60 weight % quaternary ammonium salt and about 60 weight % to about 40 weight % vinyl endblocked dimethyl polymer. Diethyl maleate is used as the adhesion promoter.

TABLE 1

| Composition 1 LSR | Composition 2 HCR |
|---|---|
| 500.0 g Wacker LR 3003/50 (Part A and | 500 g of Sanitech Ultra part A |
| Part B) | |
| 2.5 g Degussa Dynasylan 6598 | 2.5 g of diethyl maleate |
| 2.5 g Diethyl maleate | 5 g of Sanitech Ultra part B |
| 8.3 g of AMB-5 | 8.3 g of AMB-5 |

Samples are milled on a two-roll mill and test slabs are compression molded at about 350° F. for about 3 minute melt and post-cured at about 100° C. for about 4 hrs.

Samples are molded and 6″×6″ coupons are submitted for efficacy testing with both the ASTM E 2149 and the JIS Z 2801 standard against both S. aureus and E. coli.

The efficacy of the samples are displayed below in Table 2 against both S. aureus and E. coli.

TABLE 2

| | Activity on S. aureus | | Activity on E. coli | |
|---|---|---|---|---|
| Sample | Log reduction | % reduction | Log reduction | % reduction |
| Composition | 3.99 | 99.989 | 2.35 | 99.548 |
| 1 LSR | | | | |
| Composition | 3.99 | 99.989 | 4.79 | 99.998 |
| 2 HCR | | | | |

The bond strength between self-bonding, antimicrobial silicone (SB AM) and a given substrate has been tested. The silicones include those derived from Biosafe. The substrates include aluminum, stainless steel, polycarbonate and sodium naphthalene etched PTFE. Peel strength is measured according to the following procedure. Self-bonding films having a thickness of about 0.5 mm to about 1.5 mm are compression molded onto the substrates and the molding conditions are identical to physical test slabs described in Example 1. A mylar film is also molded onto the back of the silicone rubber in the same step to prevent elongation during the peel test. The peel test uses an Instron 4465 testing machine. Both silicone layer and the substrate are clamped into the Instron grip. The grip then transverses in the vertical direction at the rate of about two inch/min, which pulls the silicone 180° away from the substrate.

The results are summarized in Table 3. Comparison data for conventional rubber Wacker LR3003/50 (labeled as “Control”) on the same substrates is also included in this table.

TABLE 3
Peel Strength as molded (ppi)

| | SB AM LSR | SB AM HCR | Control |
|---|---|---|---|
| Aluminum | 52.8 | 90.5 | 0.4 |
| SS | 13.5 | 77.6 | 0.2 |
| PC | 44.7 | 81.6 | 0.2 |
| Na Naph PTFE | 16.1 | 15.6 | 1.7 |

Clearly Table 2 and Table 3 demonstrate that the silicone composition is both antimicrobially effective and provides bonding to a variety of substrates.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A silicone composition comprising:
a silicone matrix component;
an adhesion promoter; and
a quaternary ammonium salt containing polymer, wherein the quaternary ammonium salt is in an amount to provide a bactericidal effect to the silicone composition.

2. The silicone composition of claim 1, wherein the quaternary ammonium salt containing polymer also contains silicon.

3. The silicone composition of claim 2, wherein the quaternary ammonium salt containing polymer has the formula:
R₃N⁺R⁰ₙSiY⁻
wherein each R and each R⁰ are independently at each occurrence a non-hydrolysable organic group; n is an integer of 0 to 3; and Y is a suitable anionic moiety to form the salt.

4. (canceled)

5. The silicone composition of claim 2, wherein the quaternary ammonium salt containing polymer is a polymeric 3-(trimethoxysilyl)propyldimethyloctadecyl ammonium chloride.

6. The silicone composition of claim 1, wherein the silicone matrix component is a polyalkylsiloxane, a fluorosilicone, or combination thereof.

7. (canceled)

8. (canceled)

9. (canceled)

10. (canceled)

11. The silicone composition of claim 1, wherein the adhesion promoter is a silsesquioxane, an ester of unsaturated aliphatic carboxylic acid, or mixture thereof.

12. (canceled)

13. (canceled)

14. The silicone composition of claim 1, further comprising a radiation resistant additive.

15. (canceled)

16. (canceled)

17. (canceled)

18. (canceled)

19. (canceled)

20. (canceled)

21. (canceled)

22. The silicone composition of claim 1, having a bactericidal effect of at least about 2.2 log reduction to Escherichia coli.

23. (canceled)

24. The silicone composition of claim 1, wherein the quaternary ammonium salt containing polymer is homogeneously dispersed throughout the silicone composition.

25. A method of making an article comprising:
mixing a silicone matrix component, an adhesion promoter, and a quaternary ammonium salt containing polymer in a mixing device to form a silicone composition, wherein the quaternary ammonium salt containing polymer is added in an amount to provide a bactericidal effect to the silicone composition; and
forming the silicone composition into an article.

26. The method of claim 25, wherein the quaternary ammonium salt containing polymer contains silicon.

27. The method of claim 25, wherein the quaternary ammonium salt containing polymer has the formula:
R₃N⁺R⁰ₙSiY⁻
wherein each R and each R⁰ are independently at each occurrence a non-hydrolysable organic group; n is an integer of 0 to 3; and Y is a suitable anionic moiety to form the salt.

28. (canceled)

29. (canceled)

30. (canceled)

31. The method of claim 25, wherein the silicone matrix component is a polyalkylsiloxane, a fluorosilicone, or combination thereof.

32. (canceled)

33. (canceled)

34. The method of claim 25, wherein the adhesion promoter is a silsesquioxane, an ester of unsaturated aliphatic carboxylic acid, or mixture thereof.

35. (canceled)

36. (canceled)

37. (canceled)

38. (canceled)

39. The method of claim 25, further comprising disposing the silicone composition on a substrate.

40. The method of claim 25, further comprising vulcanizing the silicone composition at a temperature of about 125° C. to about 200° C. for a time of about 10 seconds to about 5 minutes.

41. The method of claim 40, further comprising post curing the silicone composition at a temperature of 60° C. to 120° C. for a time of about 1 hour to 10 hours.

42. (canceled)

43. (canceled)

44. (canceled)

45. (canceled)

46. The method of claim 25, having a bactericidal effect of at least about 2.2 log reduction to Escherichia coli.

47. (canceled)

48. (canceled)

49. An article comprising at least one layer of a silicone composition including a silicone matrix component, an adhesion promoter, a quaternary ammonium salt containing polymer, wherein the quaternary ammonium salt containing polymer is provided in an amount to provide a bactericidal effect to the silicone composition.

50. The article of claim 49, wherein the quaternary ammonium salt containing polymer contains silicon.

51. The article of claim 49, wherein the quaternary ammonium salt containing polymer has the formula:
R₃N⁺R⁰ₙSiY⁻
wherein each R and each R⁰ are independently at each occurrence a non-hydrolysable organic group; n is an integer of 0 to 3; and Y is a suitable anionic moiety to form the salt.

52. (canceled)

53. (canceled)

54. (canceled)

55. The article of claim 49, wherein the silicone matrix component is a polyalkylsiloxane, a fluorosilicone, or combination thereof.

56. (canceled)

57. (canceled)

58. The article of claim 49, wherein the adhesion promoter is a silsesquioxane, an ester of unsaturated aliphatic carboxylic acid, or mixture thereof.

59. (canceled)

60. (canceled)

61. (canceled)

62. (canceled)

63. The article of claim 49, having a bactericidal effect of at least about 2.2 log reduction to Escherichia coli.

64. (canceled)

65. The article of claim 49, further comprising at least one layer of a substrate, wherein the at least one layer of the silicone composition overlies the at least one layer of the substrate.

66. (canceled)

67. (canceled)

68. (canceled)

69. (canceled)

70. (canceled)

71. (canceled)

72. (canceled)
